(19) United States
(12) Patent Application Publication
(10) Pub. No.: US 2015/0182405 A1
(43) Pub. Date: Jul. 2, 2015

(54) AUTOMATIC WATERLESS TOILET SYSTEM WITH A DISPOSABLE SEALABLE LINER

(71) Applicant: Natasha Gradov, Allendale, NJ (US)

(72) Inventor: Natasha Gradov, Allendale, NJ (US)

(73) Assignee: REPRID LLC, Allendale, NJ (US)

(21) Appl. No.: 14/446,691

(22) Filed: Jul. 30, 2014

Related U.S. Application Data
(60) Provisional application No. 61/922,991, filed on Jan. 2, 2014.

(51) Int. Cl. A61G 9/00; A47K 11/10

(52) U.S. Cl. CPC A61G 9/003; A47K 11/105

(57) ABSTRACT

An automatic waterless toilet system comprises a reusable bedpan implement for raising a patient and a disposable collapsible liner to collect human waste therein. The liner is a rigid tray or a flexible bag insertable into the bedpan implement from one side. The bedpan implement has a motorized slider sub-system for automatic engaging and pulling the liner into a working position inside the implement and aligning thereof with a central opening in the bedpan implement and under the patient. After collection of waste within the disposable liner, it is automatically sealed and ejected from the bedpan implement such that the caregiver is protected from having to see, smell or handle an open container with human waste. The liner is made collapsible with an air escape so as to minimize its volume upon compression. The invention may be used as an alternative sewer collection system.

### CROSS-REFERENCE TO RELATED APPLICATIONS

This patent application claims a priority date benefit from a U.S. Provisional Application No. 61922991 with the same title filed Jan. 02, 2014, which is incorporated herein by reference in its entirety.

### BACKGROUND

The present invention relates generally to human waste collection devices configured for conveniently removing human waste contained therein and, more particularly, to components such as bedpans capable of holding human waste within a disposable liner. More particularly, the invention describes a waterless toilet system with a collapsible liner configured for automatic retraction and sealing after use so as to limit the risk of infection and disease exposure caused from human waste escaping the confines of the bedpan during use and/or transport. The toilet system of the invention may be used as a bedpan or in other applications.

Bedpans are commonly used for removing human waste in hospitals and nursing homes for conscious patients that are temporarily or permanently bed-ridden (e.g., patient on an operating table, patient recovering from a total hip replacement surgery, patient suffering from a stroke or heart attack, catheterization procedure, etc.) or patients that are not able to easily ambulate. Typically, a bedpan is stored next to the bed of such a patient, for example, near the patient's hospital bed, nursing home bed and/or procedure room. When the patient desires to urinate or otherwise relieve him or herself, a healthcare provider and/or caregiver positions the bedpan beneath the patient for receiving and accumulating the bodily waste expelled by the patient.

A typical conventional bedpan, made of plastic or a coated metal, is rigid, and even though it is shaped to some extent to conform to the body, at best it is always uncomfortable. In many cases a rigid bedpan is painful, especially where the patient is thin or has bed sores, is bruised, or otherwise injured. In some cases, long term use of rigid bedpans will cause bed sores. Conventional bedpans, suffer from numerous drawbacks: they are expensive, lack privacy for the patient, uncomfortable and sometimes harmful to sit or lie on; the motion of getting on them can be both painful and injurious; the lifting requirements can be physically stressful if not impossible for a healthcare provider and/or caregiver (e.g., nurse, doctor, aide, family member, etc.), particularly a home care-taker; and disposal of the contents is unpleasant and unsanitary.

If a patient is heavy, experiences pain on moving, or is simply weak, more than one caregiver may be required to lift the patient's hips high enough to allow insertion of the bedpan under the buttocks. Alternatively, the caregiver may turn him on his side before placing the bedpan and then rotate him back on to the bedpan. The movement also can be harmful if the patient has internal injuries, which in an emergency room, may not yet have been identified.

Use of a rigid conventional bedpan is also very demanding of the caregivers, more than one of whom is often required. Because they must lean over the bed, back muscles are used and consequently must be exceptionally strong to avoid injury to the caregiver. Patients who might otherwise be cared for at home are often placed in nursing homes because family members are unable to meet these lifting requirements. This alternative not only increases health care costs but is terribly demoralizing for both the patient and family.

Following insertion of a conventional bedpan under the patient and after the patient has completed expelling the bodily waste, the bedpan is typically removed from the patient and carried away by a caregiver to a restroom or similar facility for discarding of the bodily waste and rinsing or cleaning of the bedpan. Removing the bedpan with fluidic human waste (e.g., urine, feces, diarrhea, vomit, etc.) contained therein is often difficult and may expose the healthcare provider, the caregiver, the patient and other patients to a variety a harmful conditions including, for example, possible infections, exposure to diseases, drug-resistant microorganisms, exposure to skin and eye irritants, wound and skin breakdown, skin care ailments, all of which may be caused by human waste, particularly fluidic human waste escaping the confines of the bedpan.

Disposing of the waste in the conventional bedpan is also esthetically unpleasant, not only because of the sight and smell, but because flushing of the contaminated contents often results in splashing.

The significance of the problem is illustrated by the many patents on inflatable bedpans, the earliest, having been awarded in 1915. Many of these patents address primarily issues of comfort and reduced lifting. These include U.S. Pat. Nos. 1,132,056 to Wesley; 2,466,142 to Yost; 3,008,153 to Coulter; 3,464,066 to Marks; 3,628,197 to Leventhal; 3,848,274 to Oliver; 5,224,223 to Royal; and 3,609,771 to Avoy. The last also teaches a disposable waste collector, however the collector cannot be closed and exposes the caregiver to its contents. Some address methods of inflation, including U.S. Pat. Nos. 3,513,488 to Oring, 3,546,717 and 3,571,654 to Kuhn. The U.S. Patent No. 2,750,600 to MacDonald addresses not only the comfort and lifting issues but also waste evacuation via a tube; highly unsanitary by today's standards. Many prior art patents teach bedpans, which are totally disposable, and consequently more expensive. Examples of these are found in U.S. Pat. Nos. 3,418,663 to Scott; 3,605,128 to Odin; 4,437,195 to Mangels; 4,899,399 to Young; and 4,136,789 to Oberstein. All of these prior art patents are incorporated herein in their respective entireties by reference.

The need exists for a toilet system configured for automatic lifting of the patient, easy insertion of the bedpan liner, and instant sealing of the human waste at the location of the patient so that exposure to infections or diseases as well as esthetic limitations mentioned above are at least reduced or even entirely eliminated.

### SUMMARY

Accordingly, it is an object of the present invention to overcome these and other drawbacks of the prior art by providing a novel toilet system which provides privacy for the patient and improves comfort.

It is another object of the present invention to provide an expandable toilet system with a disposable liner for easy removal and disposal of the human waste.

It is a further object of the present invention to provide a toilet system configured for instant sealing of the disposable liner such that exposure to the human waste is substantially reduced if not eliminated.

It is yet a further object of the present invention to provide a toilet system that eliminates the sight and smell of the human waste.

It is yet another object of the present invention to provide a toilet system with a disposable liner which can be collapsed and therefore occupy the least amount of physical space during its disposal.

The expandable toilet system of the invention comprises a reusable bedpan implement for raising a patient and a disposable collapsible liner to collect human waste therein. The reusable bedpan implement may have a first collapsed state adapted for insertion under the patient and a second expanded state adapted for lifting the patient up and making room for a disposable liner. The liner may comprise a rigid tray or a flexible bag. It may be designed to be inserted into the bedpan implement from one side in its open state. In embodiments, the bedpan implement may have a motorized slider sub-system for automatic engaging and pulling the liner (such as by pulling on its edges) into a working position inside the implement and aligning thereof with a central opening in the bedpan implement and under the patient.

After collection of the waste within the disposable liner, the bedpan implement may be configured to automatically eject the liner while sealing thereof at the same time to put it into a closed state—such that the caregiver is protected from having to see, smell or handle an open container with human waste. The sealed liner may be then discarded. In embodiments, the liner may be made collapsible so as to minimize its volume upon compression. An air escape port may be contained within the liner and configured for allowing the air to leave the internal volume of the sealed liner while the liquid and solid waste remains behind. In embodiments, the air escape port may include a microporous hydrophobic membrane and a one-way check valve to prevent air from coming back into the internal volume of the disposable liner.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a top view of the disposable liner according to the first embodiment of the invention;

FIG. 2 is a side view of the same in expanded open state before use;

FIG. 3 is a side view of the same in collapsed sealed state after use;

FIG. 4 is a side view of the bedpan implement for use with the disposable liner of the first embodiment of the invention;

FIG. 5 is a top view of the same;

FIG. 6 is a side view of the air escape port with the one-way valve closed;

FIG. 7 is a side view of the same with the one-way valve opened;

FIG. 8 is an alternative design of the disposable liner of the first embodiment of the invention;

FIG. 9 is yet another alternative design of the same with the air escape port incorporated into a rolled up flexible membrane shown in the insert;

FIG. 10 is an alternative configuration of the air escape port of the invention, particularly suitable for use with the flexible membrane of the disposable liner shown in FIG. 9;

FIGS. 11a and 11b are respectively a front view and a side view of a flexible disposable liner bag according to a second embodiment of the invention;

FIG. 12 is a top view of the bedpan implement slider sub-system for use with the disposable liner bag of the second embodiment of the present invention;

FIG. 13 is a top view of the same showing the flexible disposable liner bag in an open state;

FIG. 14 is a side view of the disposable liner bag of the second embodiment following a roll-up and placement in a secondary container; and

FIG. 15 is a general electrical block-diagram of the control system of the invention.

### DETAILED DESCRIPTION OF PREFERRED EMBODIMENTS OF THE INVENTION

The following description sets forth various examples along with specific details to provide a thorough understanding of claimed subject matter. It will be understood by those skilled in the art, however, that claimed subject matter may be practiced without one or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

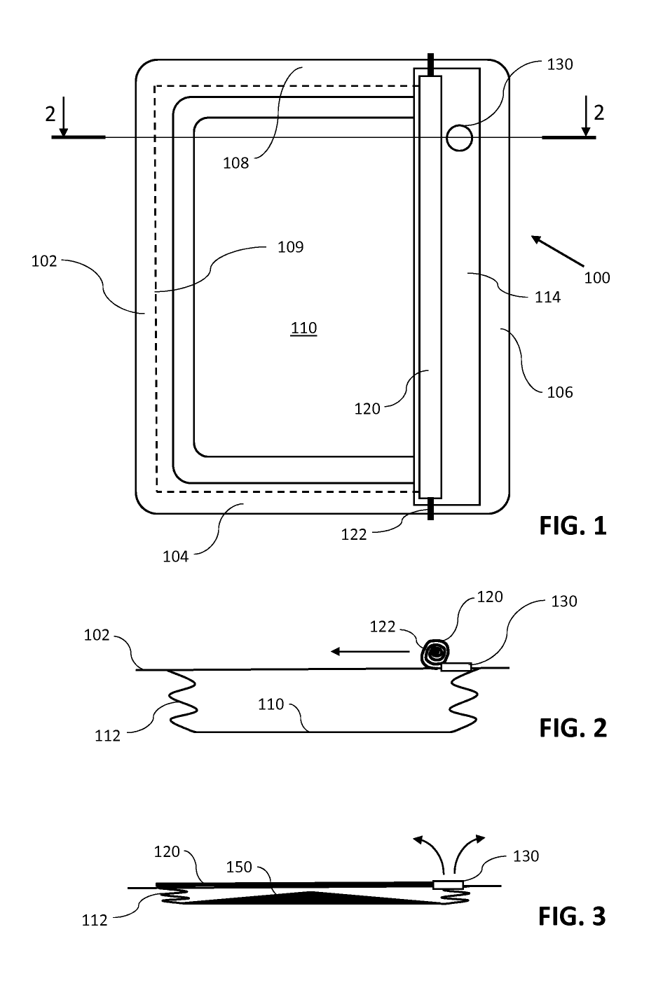

FIG. 1 shows a top view and FIG. 2 shows a side view of the disposable liner or a tray 100 according to a first embodiment of the present invention. The tray 100 is generally a rigid or a semi-rigid tray. It may be made from a suitable inexpensive polymer such as a high-impact polymer, PVC, ABS, polyethylene, polypropylene, polyurethane or a similar compound. Injection molding, thermal forming or vacuum forming techniques may be used in making the tray 100. The tray 100 may also be made from a metal foil, a carton or another paper or paper-like material, glass or other suitable material. Tray 100 may generally have a rectangular shape with rounded corners and sized to allow a sufficiently large opening in the center to accept human waste when inserted into a bedpan implement as described in more detail below.

The tray 100 may have a front edge 102, two parallel side edges 104 and 108, and a rear edge 106. At least the two side edges 104 and 108 may be made sufficiently wide so as to engage with the slider sub-system of the bedpan implement for pulling in the tray 100 and ejecting thereof from the bedpan implement as discussed below.

The tray 100 may have a collapsible section 112 made for example using bellows configuration so as to allow the bottom 110 to move closer to and further away from the plane defined by the edges 102, 104, 106, and 108—as seen in FIGS. 2 and 3. Alternatively, the tray 100 may have a flexible bottom 110a which may collapse without any bellows—as seen in FIG. 8.

The tray 100 may further be equipped with a flexible membrane cover 120, which may be initially rolled up on a central axis 122 and positioned on a ledge 114 over the bottom portion 110 of the tray 100, whereby defining an open state for the disposable liner of this first embodiment of the invention. The membrane 120 may be made from a suitable inexpensive flexible opaque polymer material having preferably at least some puncture resistant properties.

When flexible membrane 120 is rolled over the tray 100 after use thereof, the membrane may be sealed to the edges of the tray along the dashed line 109 such that the human waste is sealed inside the tray 100. Various arrangements for sealing the membrane 120 against the tray edges 102, 104, and 106 may be used including a heat leasing techniques, adhesive strips, mechanical engagement (pressing into a grove in the tray edges), etc.

The tray 100 may further include an air escape port 130 including a gas-permeable water-repellent membrane 132 enclosed in a rigid or flexible housing 134, shaped for example as a ring on the ledge 114 as well as a one-way valve 136 for directing air out of the internal volume of the tray 100. The membrane 132 may be a microporous hydrophobic membrane made from a suitable material such as a polytetrafluoroethylene, a polypropylene, a polyethylene, a polyvinylidene difluoride, a polyvinyl difluoride, and an acrylic copolymer. It may include a plurality of pores configured to allow air to move through but preventing water and other fluids and solids from passing through. In embodiments, such pores may be sized to be from about 0.01 to about 10 micrometers. The term “about” is used here and throughout the rest of this specification to mean a deviation of plus or minus 30% from the cited parameter. The membrane 132 may also include an optional coating, such as for example to increase its hydrophobic properties.

There are several approaches to forming a hermetic seal between the ring 134 and the microporous hydrophobic membrane 120. These may include ultrasonic welding, heat sealing, RF welding, and use of self-adhesive patches.

The air escape port 130 may further include a one-way valve 136 such as an air-impermeable flexible cover overlapping the ring 134. One side 138 of the cover 136 may include a flap made to allow an opening to be formed between the ring 134 and the cover 136 such as to allow air to escape from the internal volume of the tray 100—see FIG. 7. The air escape port 130 may be designed to allow air out but not back into the tray 100.

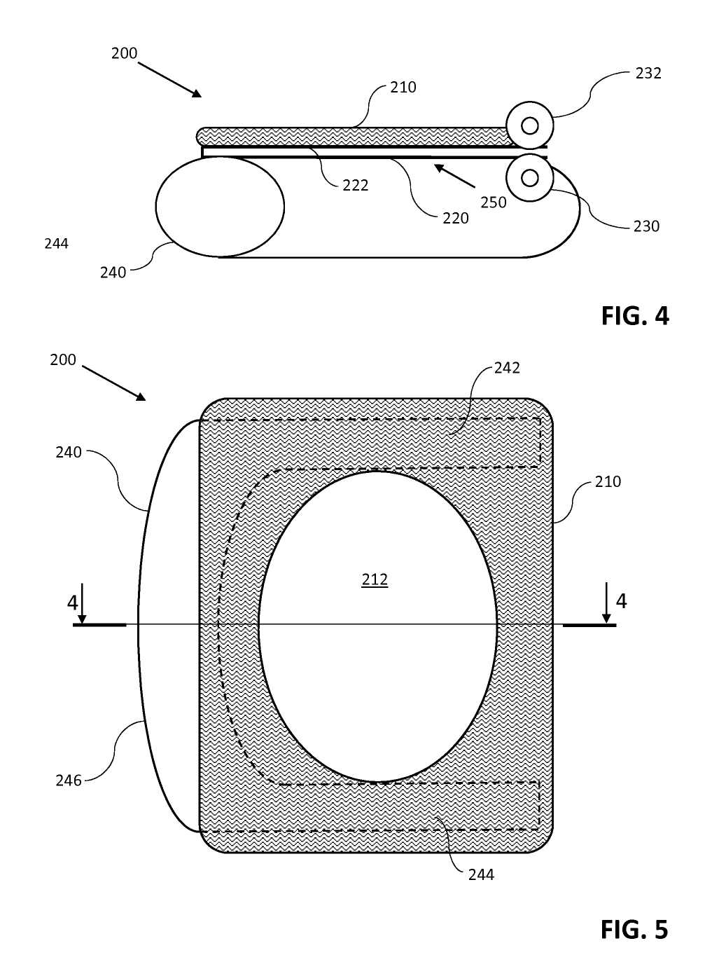

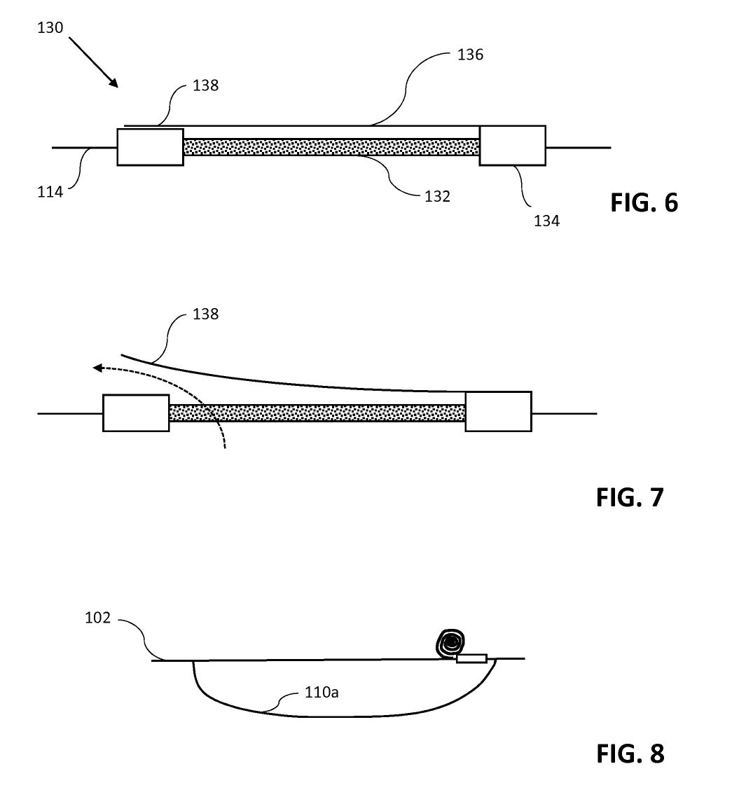

The toilet system of the present invention also includes a bedpan implement 200 suitable for use with the disposable liner such as the tray 100. One example of such implement is seen in FIGS. 4 and 5 and includes a seat 210, a slides sub-assembly 250, and an expandable cushion 240. The seat 210 may be made from a compressible foam or an inflatable bag—with a smooth cover on top for ease of cleaning and washing. The seat 210 may be designed to have a minimum thickness of about ½ to 2 inches so as to provide a soft resting surface for the patient but yet allow for a minimum overall thickness of the implement to facilitate insertion thereof under the patient. The seat 210 may further include a suitably sized top central opening 212 to expose the disposable tray to the patient when positioned over the bedpan implement 200.

The inflatable cushion 240 may be designed to allow lifting the patient positioned over the bedpan implement 200 upon inflation thereof. The cushion 240 may include a U-shaped arrangement of the two side portions 242 and 244 connected together by a bridge portion 246. The opening between the side portions 242 and 244 may be open to the side so as to allow insertion of the disposable tray 100 into the bedpan implement 200 when the cushion 240 is inflated and the patient is lifted off the bed surface.

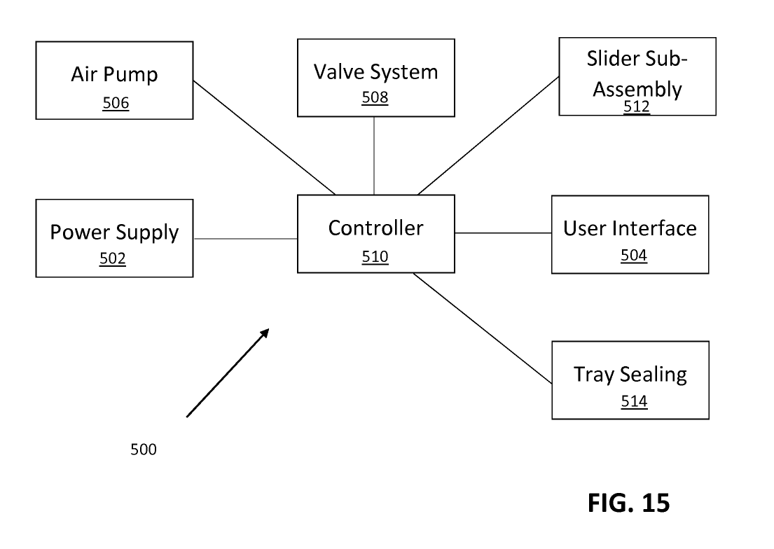

A suitable system of valves 508 may be further included and connected to the opening in the cushion 240 to facilitate its controlled inflation and deflation. An air pump 506 may also be included in the design of the toilet system. Such air pump 506 may be located to the side of the implement so as not to present a mechanical obstacle when using thereof. The air pump 506 may also be positioned away from the implement 200 and be operably connected to the inflatable cushion 240 by an air hose. The valve system 508 may include a first valve to connect the air pump 506 to the cushion 240 so as to allow filling thereof with compressed air, as well as a second valve to vent the cushion 240 to atmosphere to deflate thereof and lower the patient back to the bed surface. Such valve system 508 may be operated manually or automatically along with activating the air pump 506 using a suitable user interface 504 of an appropriate controller 510, which may form an integral part of the design of the toilet system of the present invention. Such controller 510 as well as the air pump 506, valve system 508, slider sub-assembly motors 512, tray sealing system 514 and other electrical components of the toilet system may be operated using electrical energy from a battery or a plug-in electrical power supply 502—see FIG. 15.

The bedpan implement 200 further includes a slider sub-assembly 250 configured to engage with the side edges of the tray 100, pulling thereof inside the implement 200, aligning the tray bottom 110 with the top central opening 212 prior to use, as well as for sealing the tray 100 and ejecting thereof from the implement 200 after use. The sub-assembly 250 may include a pair of parallel slides each having an upper plate 222 and a lower plate 220 (see FIG. 4) and spaced apart suitably to accept therebetween the side edges 104 and 108 of the tray 100. The slider sub-assembly 250 may further include one or two pairs of an upper roller 232 and a lower roller 230 configured to engage with the edges 104 and/or 108 for pulling in the tray 100 and ejecting thereof from the implement 200. The rollers 230 and 232 may also be used to press the membrane 120 into a groove of the tray for sealing thereof upon election. The rollers 232 and 230 may be operably connected with suitable electrical motors (not shown) for causing the rotation thereof and positioning the tray 100 within the implement 200. In embodiments, stepper electrical motors may be advantageously used for the purpose of accurate positioning of the disposable tray 100 within the bedpan implement 200. Such one or more stepper motors may be operated using a programmable controller 510.

In alternative embodiments, the slides subassembly may be designed as a simple pair of parallel slides configured to accept a manually-inserted tray 100. Tray sealing provisions may still be present to allow sealing of the tray upon removal thereof by hand.

In use, the bedpan implement 200 is first presented in a compressed state when the cushion 240 is deflated. The implement 200 may then be positioned under the patient and the cushion 240 may be inflated. Once the patient is lifted and the space is formed underneath the patient, the tray 100 may be engaged with the rollers 232 and 230 causing the tray 100 to be pulled into the interior space of the bedpan implement 200 and positioning under the top central opening 212. At this point, the patient may be instructed to complete voiding, which causes human waste to be deposited inside the disposable tray 100. The user interface 504 may then be activated to cause ejecting and sealing of the tray 100. This may be accomplished automatically by unrolling of the membrane 120 over the edges 104 and 108 as the tray 100 is being removed from the slides 222. By the time the tray 100 emerges from the slider sub-assembly 250, it is completely sealed such that the human waste is isolated from the patient and the caregiver. Ejected sealed tray 100 may be manually removed or automatically placed on a side shoot for deposit into a tray collection bin, which may be located to a side of the patient's bed.

In an alternative embodiment, the slider sub-assembly may include a heating element configured to melt the membrane 120 and heat sealing thereof to the edges of the tray 100 upon ejecting thereof from the implement 200.

To further isolate the toilet system from the patient and the caregiver, it may include an optional removable disposable cover (not shown) configured to prevent contact between the patient and any of the surfaces of the toilet system.

The sealed disposable tray 100 containing human waste may occupy a certain volume in the tray collection bin or in a trash system. To minimize that volume, it may be advantageous to remove air from the sealed tray but prevent leak of the human waste therefrom. This may be accomplished by using the air escape port 130 described above. When the tray is compressed by other trays or other trash, internal pressure may cause air to escape through the port while the membrane 132 will prevent any leakage of fluids from the tray 100. Minimizing the internal volume of the tray 100 may facilitate accumulating more trays in the tray collection bin or further compacting the trash and extending the period of time between trash disposals. The tray 100 may be subsequently burned or deposited into the landfill—similar to conventional soiled diapers.

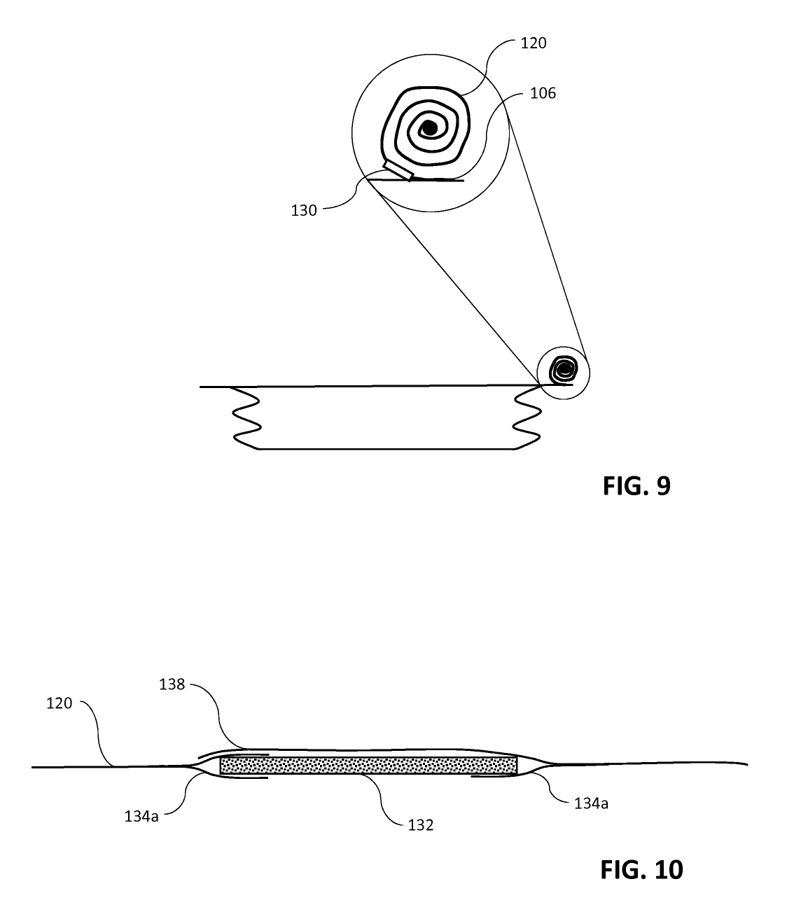

FIG. 9 shows one contemplated alternative to the design of the tray 100 in which the air escape port 130 is incorporated not into a ledge 114 but as part of the flexible membrane 120. The advantage of this arrangement is that there is no need for the ledge 114 and the membrane 120 may be positioned directly over the edge 106. To make the air escape port 130 flexible, the hydrophobic membrane 132 may be incorporated within the flexible membrane 120 between the wedges 134a using a design shown in FIG. 10.

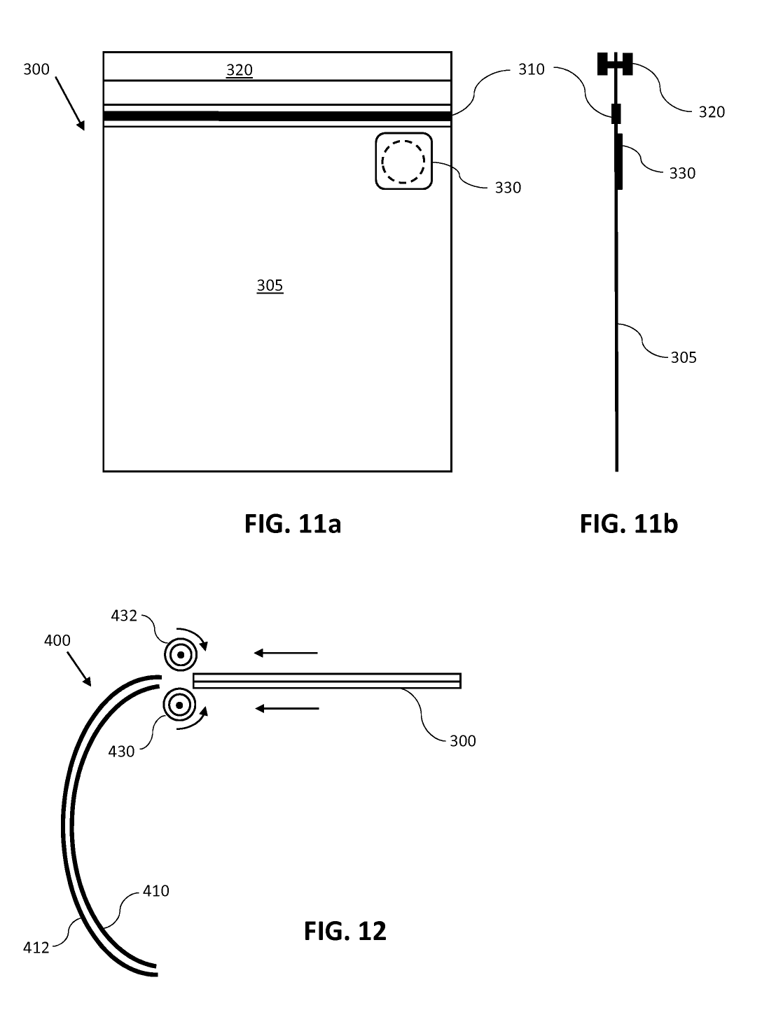

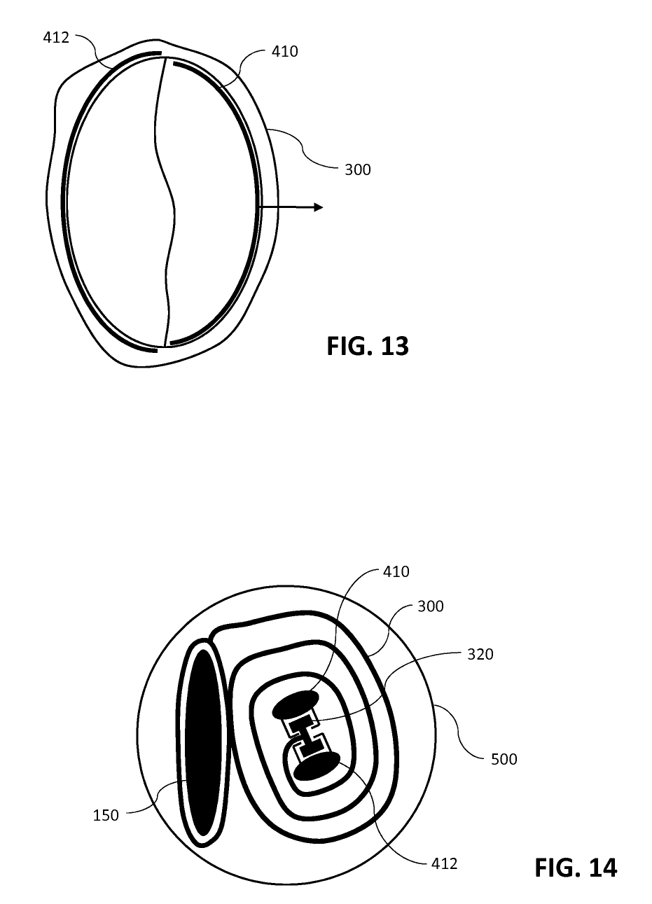

A second embodiment of the disposable liner 300 is shown in FIGS. 11a and 11b and comprises a flexible bag 305 equipped with an air escape port 330 of a similar design to that described above, a bag sealing portion 310 and a bag opening having two edges each equipped with an engagement profile 323, such as for example shaped as an I-beam or another engagement geometry. The slider sub-assembly 400 in this case may be equipped with an internal slide 410 and an external slide 412, made in the shape of a semi-circle or a semi-oval—see FIG. 12. Upon sliding into the slides 410 and 412 using the rollers 432 and 430, the flexible bag 300 may be open by inverting the internal slide 410 to complete the oval shape of the bag opening and match the top central opening of the bedpan implement—see FIG. 13. After use, the internal slide 410 may be inverted to its original position and the flexible bag 300 may be ejected from the slider sub-assembly by reversing the motion of the rollers 432 and 430.

As an additional layer of isolation of human waste from the patient and/or the caregiver, the ejected flexible bag 300 may be compressed from the sides to eject air through the air escape port 330, rolled up and placed into a rigid tube 500, which may be then sealed from both sides.

The present invention may also be used as an alternative and inexpensive sewer collection system. It may be advantageously used in conditions of lack of fresh water, difficulties with building a sewer system due to soil conditions, travel, field environment, military use, using in a vehicle or an aircraft, and other circumstances.

The herein described subject matter sometimes illustrates different components or elements contained within, or connected with, different other components or elements. It is to be understood that such depicted architectures are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Although the invention herein has been described with respect to particular embodiments, it is understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A toilet system comprising a bedpan implement having a central top opening and a disposable liner configured to be positioned in an open state within the bedpan implement and aligned with said central top opening for accepting human waste, said toilet system characterized in that said bedpan implement in turn comprising a slider sub-system for engaging with said liner and pulling thereof into said bedpan implement before use, said slider sub-system is further configured to eject said disposable liner from said bedpan implement after use while sealing said collected waste inside thereof.

2. The toilet system as in claim 1, wherein said disposable liner comprises a collapsible portion and an air escape port in fluid communication therewith, whereby after the sealing of said disposable liner and ejecting thereof from said bedpan implement, air from said liner may be removed and volume of said liner may be reduced by collapsing said collapsible portion.

3. The toilet system as in claim 2, wherein said air escape port comprising a gas-permeable water-repellent membrane and a one-way valve for directing air out of said disposable liner.

4. The toilet system as in claim 3, wherein said membrane is a microporous hydrophobic membrane.

5. The toilet system as in claim 4, wherein said microporous hydrophobic membrane is made from a material selected from a group including a polytetrafluoroethylene, a polypropylene, a polyethylene, a polyvinylidene difluoride, a polyvinyl difluoride, and an acrylic copolymer.

6. The toilet system as in claim 4, wherein said microporous hydrophobic membrane is characterized by a pore size from about 0.01 to about 10 micrometers.

7. The toilet system as in claim 3, wherein said one-way valve is a flexible gas-impermeable flap sized to cover an external side of said gas-permeable water-repellent membrane, whereby allowing air to escape from said disposable liner but preventing air to re-entry said disposable liner.

8. The toilet system as in claim 1, wherein said disposable liner comprises a rigid or semi-rigid tray having two parallel side edges, said slider sub-system further comprising a pair of spaced apart parallel slides configured to accept said side edges therein to pull said tray inside said bedpan implement.

9. The toilet system as in claim 8, wherein said tray further including a flexible cover rolled on one side of said tray prior to use, whereby defining said open state of the disposable liner, said flexible cover is sized to cover the entire opening of said tray to allow thereof to be sealed after use while being ejected from said bedpan implement.

10. The toilet system as in claim 9, wherein said slider sub-system further including a tray sealing assembly configured to seal said tray while ejecting thereof from said bedpan implement.

11. The toilet system as in claim 10, wherein said tray sealing subassembly comprising two pairs of rollers, each pair of rollers comprising a first roller and a second roller positioned adjacent to said first roller at a distance needed to exert pressure on said side edge of said tray while ejecting thereof from said bedpan implement.

12. The toilet system as in claim 11, wherein each of said side edge of said tray further comprising a groove, wherein said rollers are further configured to mechanically seal said tray by pressing said flexible membrane into said groove while ejecting said tray from said bedpan implement.

13. The toilet system as in claim 11, wherein at least one of said first roller or said second roller further comprises a heating element configured to at least partially melt at least one of said side edge or said flexible membrane so as to cause heat sealing of said tray while ejecting thereof from said bedpan implement.

14. The toilet system as in claim 9, wherein said tray further comprising a collapsible portion and an air escape port located either within said flexible cover or otherwise in fluid communication with said collapsible portion.

15. The toilet system as in claim 1, wherein said disposable liner is a flexible bag with an opening characterized by two edges each equipped with an engagement profile, said slider sub-system further including an internal slide and an external slide configured to engage with said respective engagement profiles of said disposable liner.

16. The toilet system as in claim 15, wherein said internal and said external slides are shaped as matching semi-circles or semi-ovals sized to correspond in shape to said top central opening of said bedpan implement.

17. The toilet system as in claim 16, wherein said slider sub-system is further configured to invert said internal slide after sliding said flexible bag thereon to form a complete circle or a complete oval corresponding to the shape of said top central opening, whereby causing an opening of said flexible bag to prepare thereof for accepting human waste therein.

18. The toilet system as in claim 17 further configured to invert the internal slide backwards after using said toilet system so as to cause closure and seal of said flexible bag prior to ejecting thereof from said bedpan implement.

19. The toilet system as in claim 15 further including a rigid enclosure sized to accept the flexible bag inside thereof after its use, whereby further isolating the collected human waste from subsequent human exposure.

20. The toilet system as in claim 1 further including a collection bin and a flexible shoot connecting said collection bin with said bedpan implement, whereby ejecting of said disposable liner from said bedpan implement causing an automatic hands-free transfer thereof through said flexible shoot and into said collection bin for subsequent disposal.

21. The toilet system as in claim 1, wherein said bedpan implement further comprising an inflatable U-shaped cushion with an opening oriented to allow insertion of said disposable liner into said slider sub-assembly, said inflatable cushion operably connected to a valve assembly configured to allow inflation thereof prior to use and deflation thereof after use.

22. The toilet system as in claim 21 further comprising a battery-powered or a plug-in power supply, an air pump operably connected with said valve assembly to inflate and deflate said cushion, and a controller with user interface configured to cause inflation of said cushion, pulling in said disposable liner, sealing and ejecting said disposable liner after use, and deflating of said cushion.

23. The toilet system as in claim 22, wherein said slider subassembly comprises a motorized liner positioning system configured for automatic engagement with said liner upon contact, pulling said liner and positioning thereof within said bedpan implement, and ejection thereof after use, said liner positioning system energized by said power supply and operable through said user interface by said controller.
